(19) United States
(12) Patent Application Publication
(10) Pub. No.: US 2024/0176802 A1
(43) Pub. Date: May 30, 2024

(54) SYSTEM AND METHOD FOR FAST CONSTRAINT DISCOVERY ON RELATIONAL DATA

(71) Applicant: Microsoft Technology Licensing, LLC, Redmond, WA (US)

(72) Inventors: Shaleen DEEP, Madison, WI (US); Zifan LIU, Redmond, WA (US); Ashish TIWARI, Sammamish, WA (US); Anna FARIHA, Redmond, WA (US); Avrilia FLORATOU, Sunnyvale, CA (US); Fotios PASALLIDAS, New York, NY (US)

(21) Appl. No.: 18/060,500

(22) Filed: Nov. 30, 2022

(51) Int. Cl. G06F 16/28; G06F 16/22

(52) U.S. Cl. CPC G06F 16/284; G06F 16/2246

(57) ABSTRACT

Example aspects include techniques for improved constraint discovery on relational data. These techniques may include constructing a first layer of a lattice using a first plurality of candidate denial constraints (DC) each having a first number of predicates. In addition, the techniques may include performing a tree-based verification process on the first layer of the lattice to determine one or more verified DCs confirmed to be DCs and a plurality of unverified DCs that are not confirmed to be DCs. Further, the techniques may include presenting, via a graphical user interface (GUI), DC information based on the one or more verified DC, and generating, for construction of a second layer of the lattice to be evaluated via the tree-based verification process, a second plurality of candidate DCs by combining the plurality of unverified DCs.

### BACKGROUND

Most applications incorporate a data layer for storing information and providing the information to users and/or services. Data constraint discovery is useful for many domains within the data layer context such as data integration, data science, data exploration, and query optimization. Data constraints help users understand data and ensure the quality of data. For example, relational data professionals have exhibited interest in the relationships revealed by functional dependencies and unique column combinations. However, conventional approaches to data constraint discovery suffer from bottlenecks that have rendered constraint discovery infeasible for practical applications. For example, many conventional approaches employ techniques that serially execute and result in quadratic time and space complexity.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a method including: constructing a first layer of a lattice using a first plurality of candidate denial constraints (DC) each having a first number of predicates; performing a tree-based verification process on the first layer of the lattice to determine one or more verified DCs confirmed to be DCs and a plurality of unverified DCs that are not confirmed to be DCs; presenting, via a graphical user interface (GUI), DC information based on the one or more verified DCs; and generating, for construction of a second layer of the lattice to be evaluated via the tree-based verification process, a second plurality of candidate DCs by combining the plurality of unverified DCs.

In another aspect, a device may include a memory storing instructions, and at least one processor coupled with the memory and to execute the instructions to: construct a first layer of a lattice using a plurality of first candidate denial constraints (DC) each having a first number of predicates; perform a tree-based verification process on the first layer of the lattice to determine one or more verified DCs confirmed to be DCs and a plurality of unverified DCs that are not confirmed to be DCs; present, via a graphical user interface (GUI), DC information based on the verified DCs; and generate, for construction of a second layer of the lattice to be evaluated via the tree-based verification process, a second plurality of candidate DCs by combining the plurality of unverified DCs.

In another aspect, an example computer-readable medium (e.g., non-transitory computer-readable medium) storing instructions for performing the methods described herein and an example apparatus including means of performing operations of the methods described herein are also disclosed.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 illustrates an example architecture of a relational data system, in accordance with some aspects of the present disclosure.

FIG. 2 illustrates an example lattice for constraint discovery, in accordance with some aspects of the present disclosure.

FIG. 3A illustrates an example decomposition of a candidate denial constraint, in accordance with some aspects of the present disclosure.

FIG. 3B illustrates an example candidate denial constraint verification operation, in accordance with some aspects of the present disclosure.

FIG. 4 is a flow diagram illustrating an example method for implementing data constraint discovery on relational data, in accordance with some aspects of the present disclosure.

FIG. 5 is a block diagram illustrating an example of a hardware implementation for a computing device(s), in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for implementing fast constraint discovery for relational data. Constraint discovery is useful for many domains such as data integration, data science, data exploration, and query optimization. For example, denial constraints help users understand data by revealing informative attributes and relationships, and ensure the usefulness and accuracy of the data. Some examples of denial constraints include functional dependencies, ordering dependencies, candidate keys, unique columns, and unique column combinations.

However, conventional techniques for discovering denial constraints suffer from significant bottlenecks. Most conventional techniques generate denial constraints by building evidence sets, which is a collection of predicates that encode disagreements between two tuples in a table. Once all the denial constraints have been generated, a post-processing step can calculate the support, coverage, and interestingness. This approach works well for small-sized datasets but is unscalable for larger datasets. For instance, conventional techniques for generating all of the denial constraints have a quadratic complexity in the size of the dataset, and conventional techniques implement a serial process that does not confirm the actual denial constraints of relational data until the serial process is complete. As such, conventional techniques for denial constraint discovery cannot be implemented for real-world use.

Aspects of the present disclosure provide a computationally efficient method for discovery of denial constraints of relational data. Instead of adopting the evidence-set based construction approach of conventional techniques, the present disclosure employs a lattice-based approach to generate and verify potential denial candidate constraints in increasing order of their size. As a result, the present disclosure focuses on generating denial constraints which are small in size and thus more interpretable and meaningful to a user. Further, the techniques of the present disclosure return denials constraints incrementally to the user during the discovery process via an anytime algorithm, instead of waiting for the entire process to terminate. In addition, the present disclosure employs a tree-based approach to verification which provides speed and efficiency advantages over conventional techniques. Accordingly, the present techniques significantly reduce the computational complexity (e.g. time and space complexity) and duration of denial constraint discovery so that denial constraint discovery can be employed in practical applications having data sets of varying sizes.

### Illustrative Environment

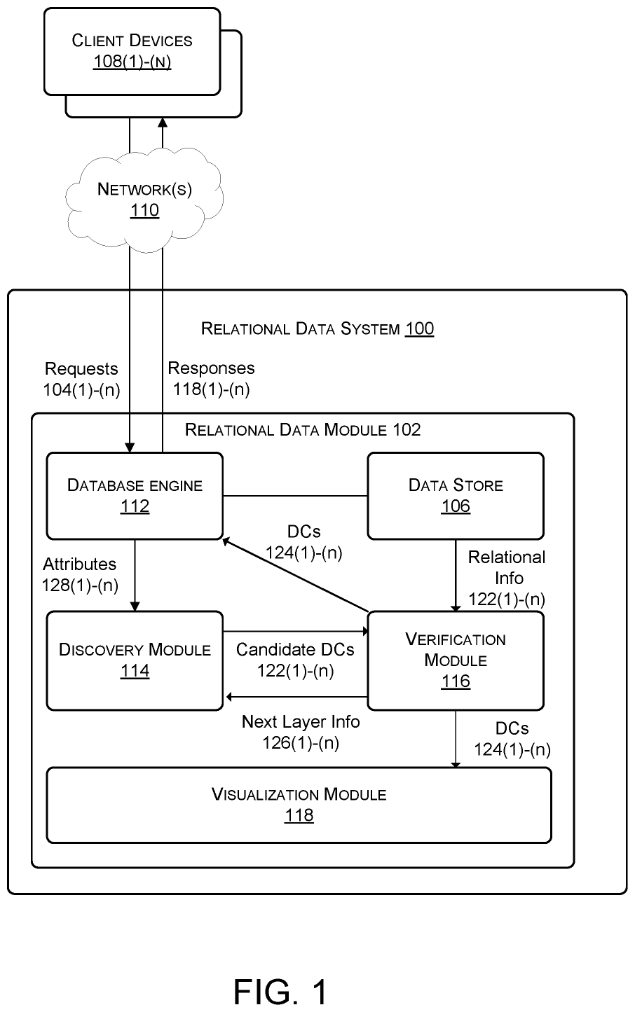

FIG. 1 is a diagram showing an example of a relational data system 100, in accordance with some aspects of the present disclosure.

As illustrated in FIG. 1, the relational data system 100 includes a relational data module 102 configured to process requests 104 over a datastore 106. Some examples of the relational data system 100 include laptop, desktops, smartphone devices, Internet of Things (IoT) devices, drones, robots, process automation equipment, sensors, control devices, vehicles, transportation equipment, tactile interaction equipment, virtual and augmented reality (VR and AR) devices, industrial machines, and virtual machines. Further, the relational data system 100 may include one or more applications that are configured to interface with the relational data module 102. For example, in some aspects, the relational data system 100 includes an application that transmits the requests 104 to the relational data module 102 for data within the datastore 106.

Another example of the relational data system 100 is a cloud computing platform that provides client devices 108 with distributed storage and access to software, services, files, and/or data via one or more network(s) 110, e.g., cellular networks, wireless networks, local area networks (LANs), wide area networks (WANs), personal area networks (PANs), the Internet, or any other type of network configured to communicate information between computing devices. Further, in some aspects, the client devices 108 include one or more applications configured to interface with the relational data system 100 and/or the relational data module 102 deployed on the relational data system 100. Further, the client devices 108 are associated with customers of the operator of the relational data system 100 or end-users that are subscribers to services and/or applications of the customers that are hosted on the relational data system 100 and provided by the customers to the end users via the relational data system 100.

For instance, in some aspects, the relational data system 100 is a provider of software as a service (SaaS), search engine as a service (SEaaS), database as a service (DaaS), storage as a service (STaaS), big data as a service (BDaaS) in a multi-tenancy environment via the Internet, and the relational data module 102 is used to service requests 104(1)-(n) submitted to the relational data system 100. Further, in some instances, the relational data system 100 is a multi-tenant environment that provides the client devices 108 with distributed storage and access to software, services, files, and/or data via one or more network(s) 110. In a multi-tenancy environment, one or more system resources of the relational data system 100 are shared among tenants but individual data associated with each tenant is logically separated. Some examples of a system resource include computing units, bandwidth, data storage, application gateways, software load balancers, memory, field programmable gate arrays (FPGAs), graphics processing units (GPUs), input-output (I/O) throughput, or data/instruction cache.

The relational data module 102 includes a database engine 112, a discovery module 114, a verification module 116, and a visualization module 118. In some aspects, the database engine 112 is configured to organize a collection of data on the datastore 106. Additionally, in some aspects, the database engine 112 and the datastore 106 reside on a single storage device or system or on multiple storage devices or systems such as available at one or more data centers. Further, the database engine 112 is configured to perform data retrieval and data manipulation. In particular, the database engine 112 receives the requests 104 for data stored within the datastore 106, and the database engine 112 generates responses 120(1)-(n) including data stored within the datastore 106 in response to the requests 106(1)-(n).

In addition, the datastore 106 includes database tables that organize the data of the datastore 106 in columns and rows. Each row represents a unique record, and each column (i.e., attribute) represents a field within the record. For example, a table of personal tax information includes a row for each person and attributes (i.e., columns) for the name, state, zip code, income, and tax bill of the person. As used herein, in some aspects, a “denial constraint” (DC) may refer to a formalism for generalization of integrity constraints (ICs) widely used in databases, such as key constraints, functional dependencies, or order dependencies. In some aspects, a denial constraint defines a set of predicates on n tuples. As used herein, in some aspects, a “tuple” may refer to an ordered set of values. Further, a relational instance satisfies a DC if for any n distinct tuples of that instance at least one predicate is violated.

Given a relation R of size N with schema (A₁, . . . , Aₖ), a DC is of the form:

∀t,t′:¬(t¹[A¹]ϕ₁u¹[B¹]∧ . . . ∧t^{k}[A^{k}]ϕ^{k}u^{k}[B^{k}]).

Where tⁱ, uⁱ∈{t, t′}; Aⁱ, Bⁱ∈{A₁, . . . Aₖ} and ϕᵢ{=, ≠, ≥, ≤, >, <}. Each clause in the conjunction is called a predicate. In some aspects, the relation R satisfies a DC if and only if the DC is satisfied for any two distinct t, t′∈R.

The discovery module 114 performs a lattice-based traversal of candidate denial constraints 122(1)-(n) in increasing order of the predicate size of the candidate denial constraints 122(1)-(n) until the predicate size is greater than a threshold (a predefined predicate maximum). Further, in some aspects, the discovery module 114 employs the verification module 116 to determine whether the candidate denial constraints 122(1)-(n) are actually denial constraints 124(1)-(n). In particular, the discovery module 114 generates a layer of a lattice from a plurality of candidate denial constraints 122. In addition, the verification module 116 determines whether the candidate denial constraints 122 of the lattice layer are denial constraints 124. Further, in some aspects, the discovery module 114 prioritizes particular attributes, predicates, and/or predicate operations for verification based on predefined priority information (e.g., user provided priority information). If a candidate denial constraint 122 of the lattice layer is a denial constraint 124, the verification module 116 provides the denial constraint 124 to the database engine 120 and/or the visualization module 118 for application and/or presentation within the relational data system 100. Alternatively, if the candidate denial constraint 122 of the lattice layer is not a denial constraint 124, the verification module 116 transmits next layer information 126 to the discovery module 114 instructing the discovery module 114 to utilize the candidate denial constraint 122 to generate the plurality of candidate denial constraints 122 for the next lattice layer.

For example, the discovery module 114 retrieves the attributes 128 of a relational instance (e.g., a database table) and begins the lattice search by adding all the candidate DCs 122 that contain exactly one predicate to layer-1 to bootstrap the process. Then, the discovery module 114 invokes a verification procedure via the verification module 116 for each candidate DC in layer-1 of the lattice. If the verification module 116 verifies that a candidate DC 122 is a DC 124, the verification module 116 transmits the DC 124 to the database engine 120 and/or the visualization module 118. Otherwise, for each predicate p∈P of a candidate DC 122 that was not verified as DC 124, the verification module 116 adds p to the next layer information 126 (e.g., a list of clauses in the conjunction of the candidate DCS 122 (Ψ) for the current layer that are used to obtain the candidate DCs 122 (Ψ″) for the next layer). Once all candidate DCs 122 in layer-1 have been processed by the verification module 116, the discovery module 114 determines whether l+1 is greater than a predicate maximum that represents how many layers of the lattice should be explored for denial constraints 124. If l+1 is less than or equal to the predefined predicate maximum, the discovery module 114 generates the next layer (e.g., layer-2) using only the predicates of the next layer information 126 (i.e., the predicates corresponding to the candidate DCs 122), the verification component identifies the DCs within current layer (e.g., layer-2) and the predicates to use to generate to the next later (e.g., layer-3), and the process continues until there are no more predicates to use to generate the next layer and/or l+1 is greater than the predefined predicate maximum.

TABLE 1

| Name | State | Zip | Income | Tax Bill |
|---|---|---|---|---|
| Alice | NY | 11803 | 28K | 2.4K |
| Mark | NY | 10102 | 42K | 4.7K |
| Bob | NY | 13914 | 93K | 11.8K |
| Mary | NY | 10437 | 58K | 6.7K |
| Alice | NY | 10437 | 26K | 2.1K |
| Julia | WA | 98112 | 24K | 1.4K |
| Jimmy | WA | 98112 | 27K | 1.6K |
| Sam | WA | 98112 | 49K | 6.8K |
| Jeff | WA | 98112 | 56K | 7.8K |
| Gary | WA | 98112 | 50K | 7.2K |
| Ron | WA | 98112 | 58K | 8K |
| Jennifer | WA | 98112 | 61K | 8.5K |
| Adam | WA | 98112 | 20K | 1K |
| Tim | IL | 62078 | 39K | 5K |
| Sarah | IL | 98112 | 54K | 5.5K |

As an example, suppose predicate space P={(t[Name] op t′[Name]), (t[State] op t′[State]), (t[Zip] op t′[Zip]), (t[Income] op t′[Income]), (t[Tax] op t′[Tax])} for each op∈{=, ≠} for the above Table 1. Consequently, the discovery module 114 is configured to generate a first layer of a lattice for Table 1 consisting of candidate DCs 122 that include one predicate from P. Further, the verification module 116 would identify two DCs 124 among the candidate DCs 122 of layer-1 for Table 1. The first DC 124 represents that the Income attribute is unique over the rows of Table 1 and the second DC 124 represents that the Tax attribute is unique over the rows of Table 1. Additionally, in response to determining that the candidate DCs 122 are DCs 124, the verification module 116 transmits a notification identifying that the candidate DCs 122 are DCs 124 to the database engine 112 and/or the visualization module 118.

Further, the remaining candidate DCs 122 of layer-1 would fail verification by the verification module 116 and be used to construct candidate DCs 122 for layer-2. For instance, the discovery module 114 would construct a candidate DC for layer-2 by combining (t[Name]=t′[Name]) with (t[State]=t′[State]), and the verification module 116 would verify that the resulting candidate DC 122 having the following predicate (t[Name]=t′[Name])∧([State]=t′[State]) constitutes a unique column combination during verification of layer-2. Additionally, in response to determining that the candidate DC 122 is a DC 124, the verification module 116 transmits a notification identifying that the candidate DC 122 is a DC 124 to the database engine 112 and/or the visualization module 118 before proceeding to another next layer.

As described above, the verification module 116 determines whether candidate DCs 122 within a lattice layer are a DC 124. In some aspects, the verification module 116 determines whether a candidate DC 122 within a lattice layer is a DC 124 based on the one or more operations within the predicates of the candidate DC 122 and the data within the datastore 106. In addition, in some aspects, the verification module 116 employs a tree structure, e.g., a nested range tree, to determine whether a candidate DC 122 is a DC 124 and count violations of the candidate DCs 122. As used herein, in some aspects, the number of violations to a candidate DC or DC is the number of tuple pairs that satisfy all the predicates of the candidate DC 122 or DC 124.

In some aspects, if a candidate DC 122 only contains the equal-to operator, the verification module 116 groups the tuples by the values of their corresponding attribute and sums the number of tuple pairs in each group. In some aspects, the verification module 116 employs a hash table to group the tuples by the values of the corresponding attribute, and determines a violation of the candidate DC 122 based on a collision within a bucket of the hash table. Further, the time and space complexity of verifying a candidate DC 122 that only contains equalities or inequalities is O(n), which is significantly less than conventional techniques.

In some aspects, if a candidate DC 122 only contains one predicate including the greater-than operator (e.g., t₀[A]>t₁[A]), the verification module 116 infers the number of violations using the same process described above with respect to the equal operator as a tuple pair must satisfy one of greater than, equal to, or less than, and the number of tuple pairs satisfying the greater than operator is the same as the number of tuple pairs satisfying less than operator.

In some aspects, if a candidate DC 122 only contains greater-than operators, equal-to operators, and/or less-than operators, the verification module 116 converts the predicates with the less than operator to predicates with greater than operator. For example, any predicate with less than can be converted to an equivalent predicate with greater than operator by negating both sides of the predicate, e.g., t₀[A]<t₁[A] is equivalent to e.g., −t₀[Income]>−t₁[Income]. After the conversion, the verification module 116 determines the number of violations by grouping the tuples by the values of attributes corresponding to predicates with the equal-to operator, counts the number violation of the predicates with other operators in each group, and sums the number of violations in all the groups.

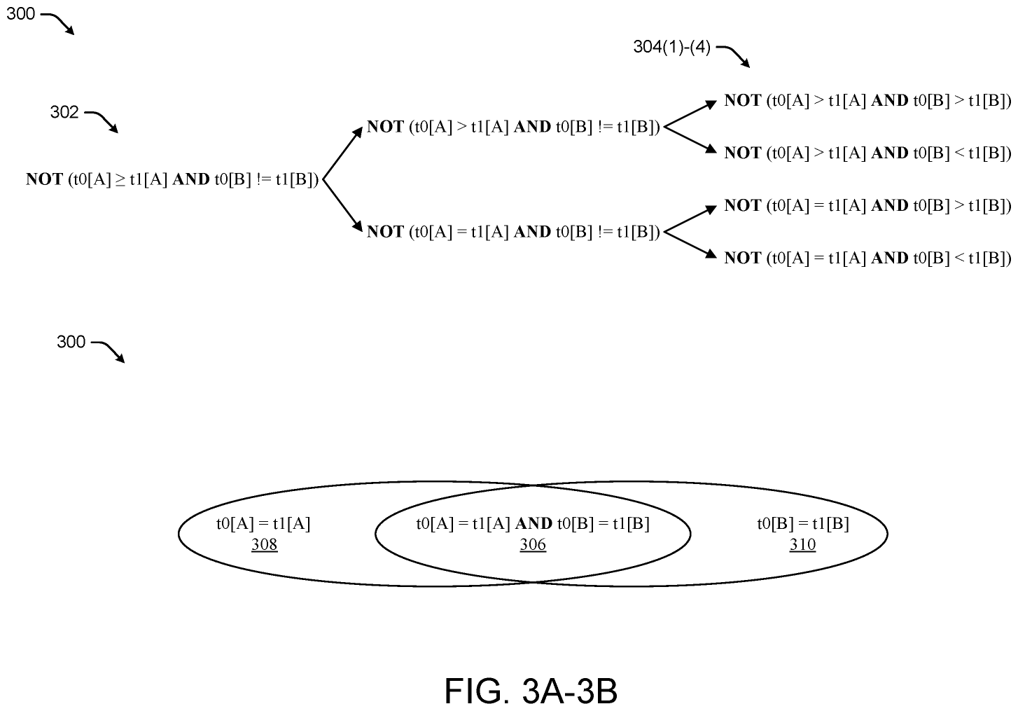

In some aspects, if a candidate DC 122 contains greater-than or equal-to operators, less-than or equal-to operators, and/or not-equal-to operators, the verification module 116 decomposes the candidate DC 122 into a candidate DC 122 having predicates that only contain greater-than operators, equal-to operators, and/or less-than operators as illustrated in FIG. 3A. In some other aspects, if a candidate DC 122 contains only equal-to operators and not-equal-to operators, the verification module 116 infers the number of violations from the corresponding constraints with only the equal-to operator as illustrated in FIG. 3B.

As described herein, in some aspects, the verification module 116 employs a nested tree to verify that a candidate DC 122 is a DC 124 and count the number of violations of candidate DC 124, which has a time complexity that is a logarithmic factor. For example, in some aspects, if a candidate DC 122 includes k predicates, the verification module 116 generates a k-dimensional nested range tree to receive bucket values from hash table generated using the predicates of a candidate DC 122. The comparison operator in the i^{th} predicate is used as the comparison operator for the i^{th} nested range tree. As the tuples are inserted sequentially in the range trees, the insertion procedure will also traverse the i^{th} nested range tree from root to the appropriate leaf. Further, each internal node of the tree keeps count of the number of children on the left and the right side of the node. While performing the tree traversal during the insertion, the verification module 116 checks at each node whether there are any tuples to the right of a node by looking at the count. Any tuple present in the subtree rooted at the right child of the node is a violation of the predicate.

In some aspects, the verification module 116 determines that a candidate DC 122 is a DC 124 based on the number of violations being zero. Additionally, or alternatively, in some aspects, the verification module 116 determines that a candidate DC 122 is a DC 124 based on the number of violations being less than a predefined threshold. For example, the verification module 116 determines that a candidate DC 122 is an approximate DC 124 based on identifying three violations with a predefined threshold of ten.

Further, in some aspects, the verification module 116 employs a sampling method to identify the DCs 124. For example, instead of using all of the rows of a database table to identify a DC 124, the verification module 116 identifies the DCs over a sample of the rows of the database table. Further, in some aspects, if the verification module 116 determines that the number of violations detected for candidate DC 122 over a sample of database table is less than the predefined threshold, the verification module 116 further generates a confidence value and only determines that the candidate DC 122 is a DC 124 when the confidence value is greater than a predefined threshold. In some aspects, the verification module 116 determines that confidence value using an error model (e.g., a gaussian or binomial error model distributions) and the sample size.

In some aspects, upon receipt of the denial constraints 124(1)-(n) from the verification module 116, the visualization module 118 presents a GUI identifying the denial constraints 124(1)-(n). In some aspects, the visualization module 118 converts the denial constraints 124(1)-(n) from logical operators to a spoken language (e.g., a conditional statement in English) or a graphical representation, and displays the converted denial constraints via the GUI. In some aspects, upon receipt of the denial constraints 124(1)-(n) from the verification module 116, the database engine 112 identifies relational data within the dataset that violates the denial constraints 124(1)-(n) and presents the identified relational data via the GUI. Additionally, or alternatively, in some aspects, the database engine 112 suggests corrections or corrects the relational data within the dataset that violates the denial constraints 124(1)-(n). For example, in some aspects, the database engine 112 employs machine learning or pattern recognition techniques to suggest corrections to or correct the relational data within the dataset that violates the denial constraints 124(1)-(n). Additionally, or alternatively, in some aspects, upon receipt of denial constraints 124(1)-(n) from the verification module 116, the database engine 112 flags database input that violates the denial constraints 124(1)-(n). Further, in some aspects, the database engine 112 denies entry of the database input to the datastore 106 or requests confirmation the user intends or is allowed to violate the denial constraints 124.

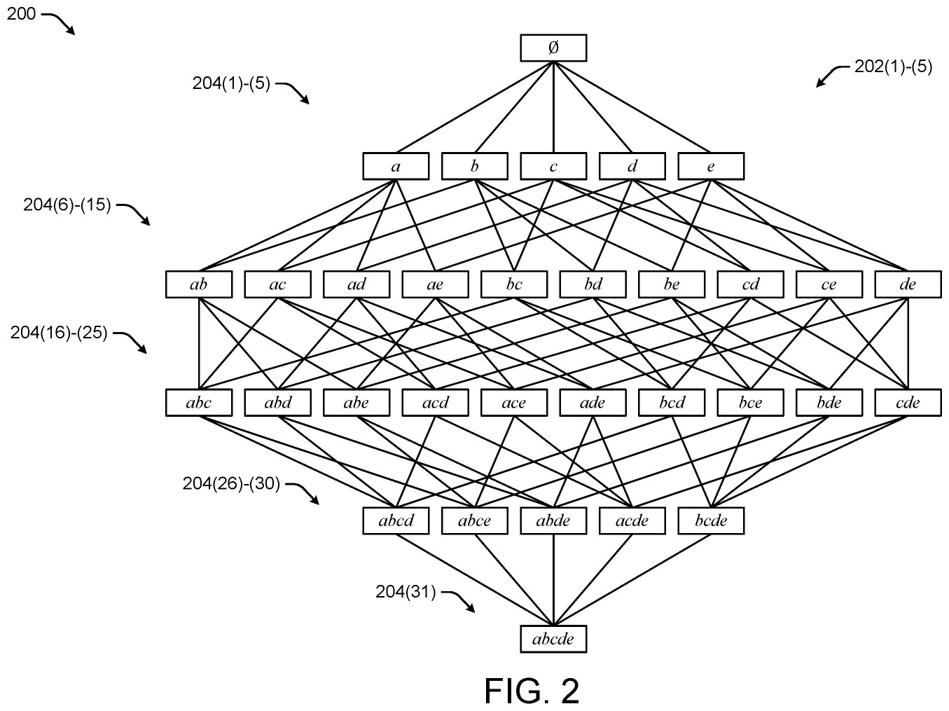

FIG. 2 illustrates an example lattice for constraint discovery, in accordance with some aspects of the present disclosure. As illustrated in FIG. 2, a lattice 200 may include different layers 202(1)-(5) including a plurality of predicates 204(1)-(31). Although FIG. 2 displays five layers and thirty-one predicates, a lattice may include more or less than five layers. Further, as illustrated in FIG. 2, in some aspects, the predicates 204 from the earlier layers 202 are combined to construct the predicates 204 in subsequent layers 202. For example, as described herein, the discovery module 114 combines the predicates 204(1)-(5) of layer-1 202(1) to generate the predicates 202(6)-(15) of layer-2. Further, as described herein, if the verification module 116 determines that a candidate DC 122 is a denial constraint or approximate denial constraint 122, the discovery module 114 prunes the one or more predicates corresponding to the denial constraint or approximate denial constraint 122 by removing the one or more predicates from the set of predicates used to generate the next layer of predicates. Additionally, logically redundant predicates are not added to lattice 200. E.g., if the verification module 116 determines that ¬(t0[A]=t1[A]) is not violated, then (t0[A]!=t1[A]) will not be included in the next layer of predicates.

FIG. 3A illustrates an example decomposition of a candidate denial constraint, in accordance with some aspects of the present disclosure. As illustrated in FIG. 3A, in some aspects, the verification module 116 decomposes a candidate DC 302 that includes greater-than or equal-to, less-than or equal-to, and/or not-equal-to. In particular, the verification module 116 decomposes the candidate DC 302 into four candidate DCs 304(1)-(4) that only contain greater-than, less-than, and/or equal-to, and can be verified by the verification module 116.

FIG. 3B illustrates an example candidate denial constraint verification operation, in accordance with some aspects of the present disclosure. As illustrated in FIG. 3B, a denial constraint 306 can overlap with other denial constrains 308 and 310. Further, in order to avoid redundant expensive operations, in some aspects, the verification module 116 employs a hash table to identify and reuse previously-evaluated predicates.

### Example Processes

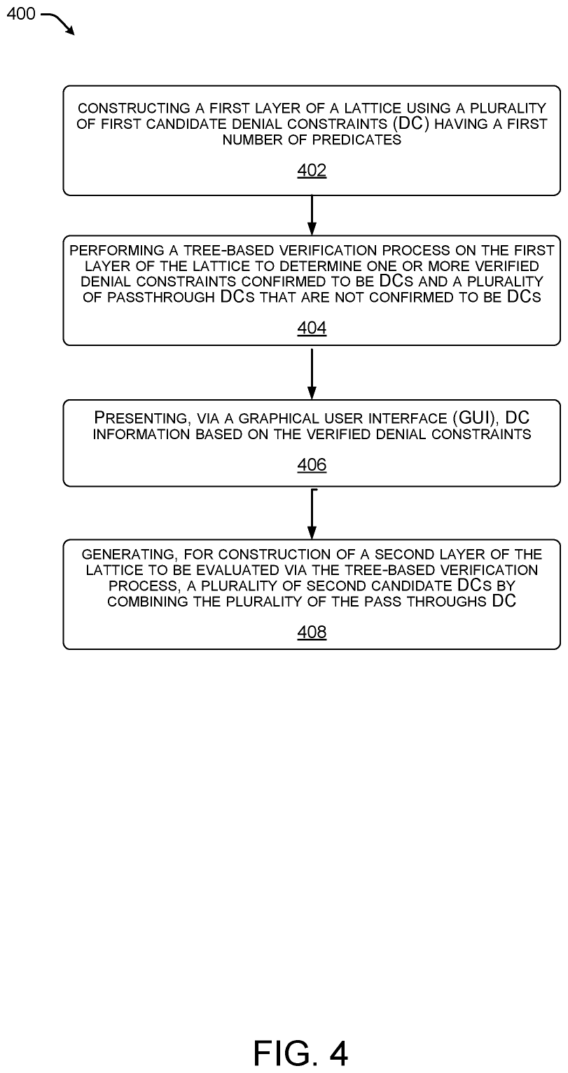

FIG. 4 is a flow diagram illustrating an example method 400 for implementing vendor-agnostic state and configuration collection from network devices, in accordance with some aspects of the present disclosure. The method 400 is performed by one or more components of the relational data system 100, the computing device 500, or any device/component described herein according to the techniques described with reference to the previous figures.

At block 402, the method 400 includes constructing a first layer of a lattice using a first plurality of candidate denial constraints (DC) each having a first number of predicates. For example, the discovery module 114 generates a layer l of a lattice for a database table. Further, the layer l includes one or more candidate DCs 122 each having l number of predicates.

Accordingly, the relational data system 100, the computing device 500, and/or the processor 502 executing the discovery module 114 provides means for constructing a first layer of a lattice using a first plurality of candidate denial constraints (DC) each having a first number of predicates.

At block 404, the method 400 includes performing a tree-based verification process on the first layer of the lattice to determine one or more verified DCs confirmed to be DCs and a plurality of unverified DCs that are not confirmed to be DCs. For example, the verification module 116 determines whether each of the candidate DCs 122 of the layer l is a DC 124 based upon the rows of the database table and the predicates of the candidate DC 122. Further, if the verification module 116 determines that a candidate DC 122 is a DC 124, the verification module 116 immediately transmits the DC 124 to the database engine 120 and/or the visualization module 118. Otherwise, if the candidate DC 122 of the lattice layer is not a DC 124, the verification module 116 transmits next layer information 126 to the discovery module 114 identifying the candidate DC 122

Accordingly, the relational data system 100, the computing device 500, and/or the processor 502 executing the verification module 116 provides means for performing a tree-based verification process on the first layer of the lattice to determine one or more verified DCs confirmed to be DCs and a plurality of unverified DCs that are not confirmed to be DCs.

At block 406, the method 400 includes presenting, via a graphical user interface (GUI), DC information based on the one or more verified DCs. For example, the visualization module 118 presents information identifying the DCs 124 detected by the verification module 116. In some examples, the visualization module 118 presents the DCs 124 via the GUI. In some other examples, the visualization module 118 presents data (e.g., rows) within the datastore 106 that violates the DCs 124 detected by the verification module 116. Further, in some aspects, the visualization module 118 applies one or more graphical effects (e.g., coloring, shading, animation, etc.) to the data within the datastore 106 that violates the DCs 124 detected by the verification module 116. As another example, in some aspects, the database engine 112 flags database input that violates the DCs 124 detected by the verification module 116 instead of adding the database input to database.

Accordingly, the relational data system 100, the computing device 500, and/or the processor 502 executing the database engine 112 and/or the visualization module 118 provides means for presenting, via a graphical user interface (GUI), DC information based on the one or more verified DCs.

At block 408, the method 400 includes generating, for construction of a second layer of the lattice to be evaluated via the tree-based verification process, a second plurality of candidate DCs by combining the plurality of unverified DCs. For example, the discovery module 114 generates a layer l+1 of the lattice for the database table. Further, the layer l+1 includes one or more candidate DCs 122 each having l+1 number of predicates. In addition, the predicates of the candidate DCs 122 of layer l+1 are constructed using the predicates of the candidates DCs 122 identified within the next layer information 126 received from the verification module 116 as not being denial constraints.

Accordingly, the relational data system 100, the computing device 500, and/or the processor 502 executing the discovery module 114 provides means for generating, for construction of a second layer of the lattice to be evaluated via the tree-based verification process, a second plurality of candidate DCs by combining the plurality of unverified DCs.

In some aspects, the techniques described herein relate to the method 400, wherein each of the second plurality of candidate DCs has a second number of predicates that is greater than the first number of predicates, and wherein generating the second plurality of candidate DCs includes: generating the second plurality of candidate DCs based on the second number of predicates being less than a predefined threshold.

In some aspects, the techniques described herein relate to the method 400, wherein performing the tree-based verification process on the first layer of the lattice includes wherein performing the tree-based verification process on the first layer of the lattice using a hash table and/or a nested range tree.

In some aspects, the techniques described herein relate to the method 400, wherein performing a verification process on the first layer of the lattice: determining a number of violations associated with a candidate DC of the first plurality of candidate DCs; and determining that the candidate DC is a DC based at least in part on the number of violations being less than a predefined threshold.

In some aspects, the techniques described herein relate to the method 400, wherein performing a verification process on the first layer of the lattice includes: determining a number of violations of a candidate DC of the first plurality of candidate DCs based on a child of a node of a nested range tree, wherein the node corresponds to the candidate DC; and determining that the candidate DC is a DC based at least in part on the number of violations being less than a predefined threshold.

In some aspects, the techniques described herein relate to the method 400, wherein performing a verification process on the first layer of the lattice includes: sampling a database second plurality of candidate DCs table to generate a sample dataset; determining a number of violations of a candidate DC of the first plurality of candidate DCs within the sample dataset; and determining that the candidate DC is a DC based at least in part on the number of violations being less than a first predefined threshold and a confidence value associated with the sample dataset being greater than a second predefined threshold.

In some aspects, the techniques described herein relate to the method 400, wherein presenting the DC information includes: identifying a conflict between a proposed database input and a DC of the one or more verified DCs; denying, based on the conflict, entry of the proposed database input; and displaying, via the GUI, the DC information indicating that the proposed database input conflicts with the DC.

In some aspects, the techniques described herein relate to the method 400, wherein presenting the DC information includes: identifying a conflict between a database entry and a DC of the one or more verified DCs; and displaying, via the GUI, the DC information indicating identification of the conflict.

In some aspects, the techniques described herein relate to the method 400, wherein a verified DC of the one or more verified DCs is at least one of a functional dependency, a unique column, a unique column combination, or an ordering constraint.

While the operations are described as being implemented by one or more computing devices, in other examples various systems of computing devices may be employed. For instance, a system of multiple devices may be used to perform any of the operations noted above in conjunction with each other.

### Illustrative Computing Device

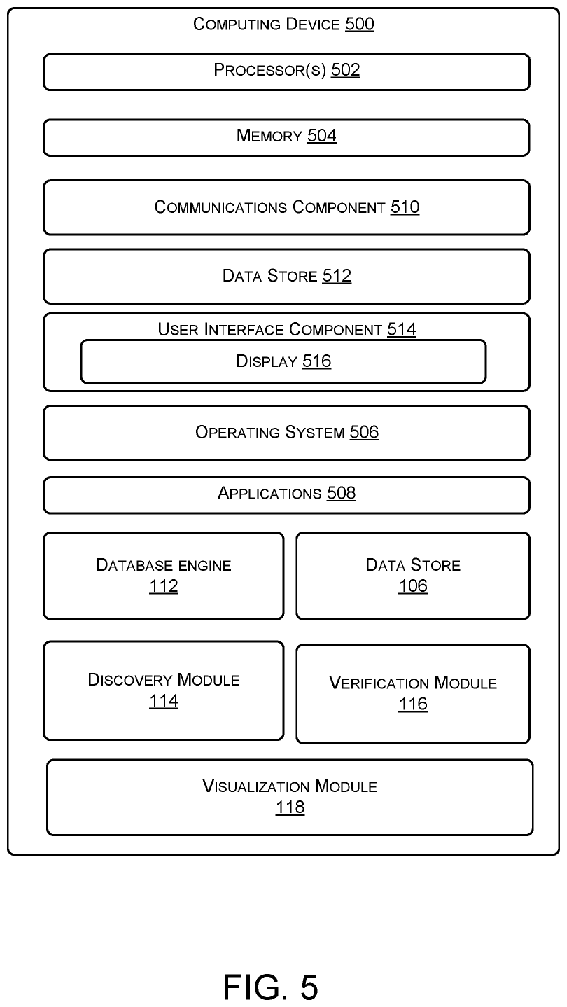

Referring now to FIG. 5, an example of a computing device(s) 500 (e.g., the relational data system 100). In one example, the computing device(s) 500 includes the processor 502 for carrying out processing functions associated with one or more of components and functions described herein. The processor 502 includes a single or multiple set of processors or multi-core processors. Moreover, in some aspects, the processor 502 is implemented as an integrated processing system and/or a distributed processing system. In an example, the processor 502 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 502 may include other processing components such as one or more arithmetic logic units (ALUs), registers, or control units.

In an example, the computing device 500 also includes memory 504 for storing instructions executable by the processor 502 for carrying out the functions described herein. The memory 504 may be configured for storing data and/or computer-executable instructions defining and/or associated with the database engine 112, the discovery module 114, the verification module 116, and the visualization module 118, and the processor 502 may execute the database engine 112, the discovery module 114, the verification module 116, and the visualization module 118. An example of memory 504 may include, but is not limited to, a type of memory usable by a computer, such as random access memory (RAM), read only memory (ROM, optical discs, volatile memory, non-volatile memory, and any combination thereof. In an example, the memory 504 may store local versions of applications being executed by processor 502.

The example computing device 500 includes a communications component 510 that provides for establishing and maintaining communications with one or more other devices utilizing hardware, software, and services as described herein. The communications component 510 may carry communications between components on the computing device 500, as well as between the computing device 500 and external devices, such as devices located across a communications network and/or devices serially or locally connected to the computing device 500. For example, the communications component 510 may include one or more buses, and may further include transmit chain components and receive chain components associated with a transmitter and receiver, respectively, operable for interfacing with external devices.

The example computing device 500 includes a datastore 512, which may be any suitable combination of hardware and/or software, that provides for mass storage of information, databases, and programs employed in connection with implementations described herein. For example, the datastore 512 may be a data repository for the operating system 506 and/or the applications 508.

The example computing device 500 includes a user interface component 514 operable to receive inputs from a user of the computing device 500 and further operable to generate outputs for presentation to the user (e.g., a presentation of a GUI). The user interface component 514 may include one or more input devices, including but not limited to a keyboard, a number pad, a mouse, a touch-sensitive display (e.g., display 516), a digitizer, a navigation key, a function key, a microphone, a voice recognition component, any other mechanism capable of receiving an input from a user, or any combination thereof. Further, the user interface component 514 may include one or more output devices, including but not limited to a display (e.g., display 516), a speaker, a haptic feedback mechanism, a printer, any other mechanism capable of presenting an output to a user, or any combination thereof.

In an implementation, the user interface component 514 may transmit and/or receive messages corresponding to the operation of the operating system 506 and/or the applications 508. In addition, the processor 502 executes the operating system 506 and/or the applications 508, and the memory 504 or the datastore 512 may store them.

Further, one or more of the subcomponents of the database engine 112, the discovery module 114, the verification module 116, and the visualization module 118 may be implemented in one or more of the processor 502, the applications 508, the operating system 506, and/or the user interface component 514 such that the subcomponents of the database engine 112, the discovery module 114, the verification module 116, and the visualization module 118 are spread out between the components/subcomponents of the computing device 500.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Non-transitory computer-readable media excludes transitory signals. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
constructing, for a dataset stored by a database engine, a lattice for traversing candidate denial constraints (DC) in increasing order of predicate size, including a first layer of the lattice using a first plurality of candidate DCs each having a same first number of predicates;
performing a tree-based verification process on the first layer of the lattice to determine one or more verified DCs confirmed to be DCs and a plurality of unverified DCs that are not confirmed to be DCs;
presenting, via a graphical user interface (GUI), DC information including an indication of the one or more verified DCs; and
generating, for construction of a second layer of the lattice to be evaluated via the tree-based verification process, a second plurality of candidate DCs by combining subsets of the plurality of unverified DCs so that each candidate DC in the second plurality of candidate DCs has a same second number of predicates.

2. The method of claim 1, wherein generating the second plurality of candidate DCs occurs after presenting the DC information via the GUI.

3. The method of claim 1, wherein performing the tree-based verification process on the first layer of the lattice comprises performing the tree-based verification process on the first layer of the lattice using a hash table and/or a nested range tree.

4. The method of claim 1, wherein performing a verification process on the first layer of the lattice:
determining a number of violations associated with a candidate DC of the first plurality of candidate DCs; and
determining that the candidate DC is a DC based at least in part on the number of violations being less than a predefined threshold.

5. The method of claim 1, wherein performing a verification process on the first layer of the lattice comprises:
determining a number of violations of a candidate DC of the first plurality of candidate DCs based on a child of a node of a nested range tree, wherein the node corresponds to the candidate DC; and
determining that the candidate DC is a DC based at least in part on the number of violations being less than a predefined threshold.

6. The method of claim 1, wherein performing a verification process on the first layer of the lattice comprises:
sampling a database second plurality of candidate DCs table to generate a sample dataset;
determining a number of violations of a candidate DC of the first plurality of candidate DCs within the sample dataset; and
determining that the candidate DC is a DC based at least in part on the number of violations being less than a first predefined threshold and a confidence value associated with the sample dataset being greater than a second predefined threshold.

7. The method of claim 1, wherein presenting the DC information comprises:
identifying a conflict between a proposed database input and a DC of the one or more verified DCs;
denying, based on the conflict, entry of the proposed database input; and
displaying, via the GUI, the DC information indicating that the proposed database input conflicts with the DC.

8. The method of claim 1, wherein presenting the DC information comprises:
identifying a conflict between a database entry and a DC of the one or more verified DCs; and
displaying, via the GUI, the DC information indicating identification of the conflict.

9. The method of claim 1, wherein a verified DC of the one or more verified DCs is at least one of a functional dependency, a unique column, a unique column combination, or an ordering constraint.

10. A system comprising:
a memory storing instructions thereon; and
at least one processor coupled with the memory and configured by the instructions to:
construct, for a dataset stored by a database engine, a lattice for traversing candidate denial constraints (DC) in increasing order of predicate size, including a first layer of the lattice using a first plurality of candidate DCs each having a same first number of predicates;
perform a tree-based verification process on the first layer of the lattice to determine one or more verified DCs confirmed to be DCs and a plurality of unverified DCs that are not confirmed to be DCs;
present, via a graphical user interface (GUI), DC information including an indication of the one or more verified DCs; and
generate, for construction of a second layer of the lattice to be evaluated via the tree-based verification process, a second plurality of candidate DCs by combining subsets of the plurality of unverified DCs so that each candidate DC in the second plurality of candidate DCs has a same second number of predicates.

11. The system of claim 10, wherein to generate the second plurality of candidate DCs occurs after presenting the DC information via the GUI.

12. The system of claim 10, wherein to perform the tree-based verification process on the first layer of the lattice the at least one processor is further configured by the instructions to perform the tree-based verification process on the first layer of the lattice using a hash table and/or a nested range tree.

13. The system of claim 10, wherein to perform a verification process on the first layer of the lattice the at least one processor is further configured by the instructions to:
determine a number of violations associated with a candidate DC of the first plurality of candidate DCs; and
determine that the candidate DC is a DC based at least in part on the number of violations being less than a predefined threshold.

14. The system of claim 10, wherein to perform a verification process on the first layer of the lattice the at least one processor is further configured by the instructions to:
determine a number of violations of a candidate DC of the first plurality of candidate DCs based on a child of a node of a nested range tree, wherein the node corresponds to the candidate DC; and
determine that the candidate DC is a DC based at least in part on the number of violations being less than a predefined threshold.

15. The system of claim 10, wherein to present the DC information comprises the at least one processor is further configured by the instructions to:
identify a conflict between a proposed database input and a DC of the one or more verified DCs;
deny, based on the conflict, entry of the proposed database input; and
display, via the GUI, the DC information indicating that the proposed database input conflicts with the DC.

16. The system of claim 10, wherein to present the DC information comprises the at least one processor is further configured by the instructions to:
identify a conflict between a database entry and a DC of the one or more verified DCs; and
display, via the GUI, the DC information indicating identification of the conflict.

17. A non-transitory computer-readable device having instructions thereon that, when executed by at least one computing device, cause the at least one computing device to perform operations comprising:
constructing, for a dataset stored by a database engine, a lattice for traversing candidate denial constraints (DC) in increasing order of predicate size, including a first layer of the lattice using a first plurality of candidate DCs each having a same first number of predicates;
performing a tree-based verification process on the first layer of the lattice to determine one or more verified DCs confirmed to be DCs and a plurality of unverified DCs that are not confirmed to be DCs;
presenting, via a graphical user interface (GUI), DC information including an indication of the one or more verified DCs; and
generating, for construction of a second layer of the lattice to be evaluated via the tree-based verification process, a second plurality of candidate DCs by combining subsets of the plurality of unverified DCs so that each candidate DC in the second plurality of candidate DCs has a same second number of predicates.

18. The non-transitory computer-readable device of claim 17, wherein generating the second plurality of candidate DCs occurs after presenting the DC information via the GUI.

19. The non-transitory computer-readable device of claim 17, wherein performing a verification process on the first layer of the lattice:
determining a number of violations associated with a candidate DC of the first plurality of candidate DCs; and
determining that the candidate DC is a DC based at least in part on the number of violations being less than a predefined threshold.

20. The non-transitory computer-readable device of claim 17, wherein a verified DC of the one or more verified DCs is at least one of a functional dependency, a unique column, a unique column combination, or an ordering constraint.

21. The method of claim 1, wherein the database engine uses the one or more verified DCs and one or more second layer verified DCs, verified from the second plurality of candidate DCs, to determine whether data in the dataset satisfies the one or more verified DCs and the one or more second layer verified DCs.
